(19) United States
(12) Patent Application Publication
(10) Pub. No.: US 2026/0275863 A1
(43) Pub. Date: Sep. 17, 2026

(54) System And Method For Automated Quantitative Seismic Interpretation

(71) Applicant: Chevron U.S.A. Inc., San Ramon, CA (US)

(72) Inventors: Un Young Lim, Katy, TX (US); Casey Lee Hagbo, Katy, TX (US)

(21) Appl. No.: 19/561,457

(22) Filed: Mar. 9, 2026

Related U.S. Application Data
(60) Provisional application No. 63/770,612, filed on Mar. 12, 2025.

(51) Int. Cl. E21B 49/00; G01V 1/30

(52) U.S. Cl. CPC E21B 49/00; G01V 1/305; G01V 1/306; E21B 2200/20; E21B 2200/22

(57) ABSTRACT

A method is described for automated quantitative seismic interpretation. The method uses automated well-tie methods to calculate time to depth relationships, deep neural network (DNN) wavelet estimation, and deep neural network (DNN) seismic AVA inversion. The proposed integrated QI workflow ultimately reduces human bias and labor while providing streamlined, accurate reservoir property estimations. The method is executed by a computer system.

### CROSS-REFERENCE TO RELATED APPLICATIONS

The present application claims priority to U.S. Provisional Patent Application No. 63/770,612 filed Mar. 12, 2025, the entire content of which is incorporated herein by reference.

### STATEMENT REGARDING FEDERALLY SPONSORED RESEARCH OR DEVELOPMENT

Not applicable.

### TECHNICAL FIELD

The disclosed embodiments relate generally to techniques for interpretation of seismic images representative of subsurface volumes of interest that may include hydrocarbon reservoirs. In particular, the disclosed embodiments use improved well-tie methods and machine-learning techniques to enable seismic interpretation.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for more efficient and accurate methods of seismic interpretation in order to better understand the locations of rock and fluid property changes that will facilitate hydrocarbon production.

### SUMMARY

In accordance with some embodiments, a method is disclosed for automated quantitative seismic interpretation. In an embodiment, the method uses automated well-tie methods to calculate time to depth relationships, deep neural network (DNN) wavelet estimation, and deep neural network (DNN) seismic AVA inversion.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for automated quantitative seismic interpretation;

FIG. 2 illustrates an example method for automated quantitative seismic interpretation;

FIG. 3A illustrates a method for a step of an example method for automated quantitative seismic interpretation; and

FIG. 3B illustrates a comparison of the method illustrated in FIG. 3A against a conventional result.

Like reference numerals refer to corresponding parts throughout the drawings.

### DETAILED DESCRIPTION OF EMBODIMENTS

Described below are methods, systems, and computer readable storage media that provide a manner of automated seismic interpretation. These embodiments are designed to be of particular use for automated depth calibration, seismic wavelet estimation, and seismic amplitude variation with angle (AVA) inversion as a complete workflow for the seismic interpretation.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The embodiments described herein present a fully automated quantitative seismic interpretation (QI) workflow that integrates three automated methodologies to rapidly generate high-quality predictions of reservoir properties. A central focus is placed on the automated depth calibration achieved through an automated well-tie system, which employs Parallel Tempering Markov-Chain Monte Carlo (PT-MCMC) simulations to explore an immense number of perturbations in well-tie parameters. By doing so, an optimized Time-Depth Relationship (TDR) and reflectivity model are generated-capabilities that are beyond manual processing. This optimized TDR is then passed to a Deep Neural Network (DNN) based wavelet estimation module (with a fixed reflectivity model), ensuring that the estimated wavelet accurately captures the Earth's response. Finally, an end-to-end DNN-based seismic AVA inversion uses the refined wavelet to produce inversion results that are well-aligned with log data at well locations. The proposed integrated QI workflow ultimately reduces human bias and labor while providing streamlined, accurate reservoir property estimations.

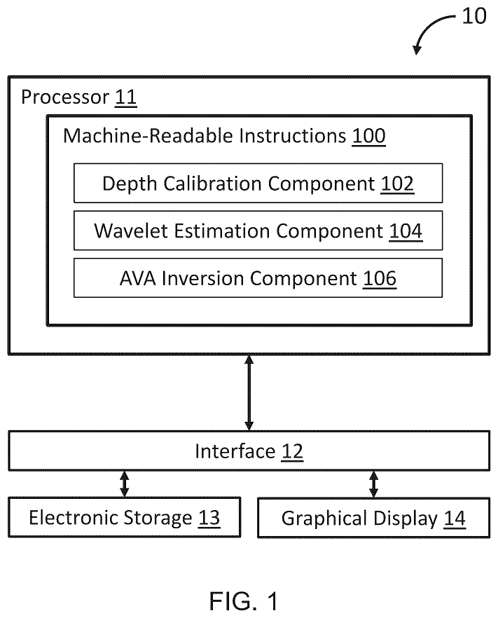

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to input seismic data and well logs, and/or other information. For example, the electronic storage 13 may store information relating to output time-to-depth conversion, estimated wavelets, AVA inversion results, seismic interpretation, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to time-to-depth conversion, estimated wavelets, AVA inversion results, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate automated seismic interpretation. The machine-readable instructions 100 may include one or more computer program components. The machine-readable instructions 100 may include a depth calibration component 102, a wavelet estimation component 104, an AVA inversion component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the depth calibration component 102 may be configured to perform automated depth calibration. In an embodiment, this may be performed using a method such as the one disclosed in U.S. Pat. No. 11,275,193.

The wavelet estimation component 104 may be configured to estimate the seismic wavelets. This may be done, by way of example and not limitation, by generating a synthetic training dataset by convolving a nominal wavelet (e.g., a 25 Hz Ricker wavelet) with a variety of reflectivity models. A deep neural network (DNN) can then be trained to learn the mapping from seismic data to the estimated wavelet.

The AVA inversion component 106 may be configured to perform seismic AVA inversion. This may be done, for example, using the method described in U.S. Pat. No. 11,409,013.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

Quantitative seismic interpretation is essential for accurate reservoir characterization and hydrocarbon exploration. Traditional workflows require manual well ties-stretching, squeezing, and shifting well logs—to match seismic reflectors with subsurface markers. Such manual processes are not only labor intensive and subjective, but they also struggle to explore the vast solution space of well-tie perturbations, often resulting in a suboptimal Time-Depth Relationship (TDR). Workflow automation drives operational excellence by optimizing seismic inversion processes, enhancing the quality of results, reducing the time required, and providing valuable insights for well placement and completion design.

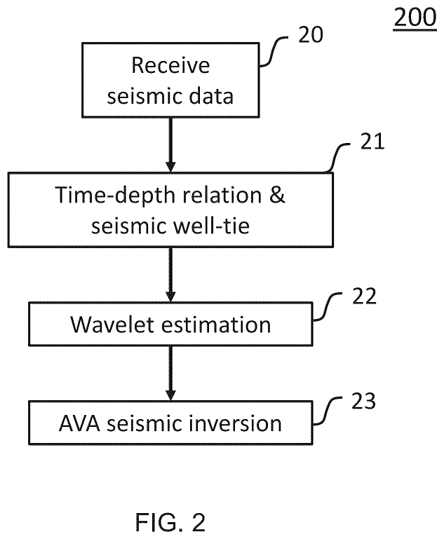

The present invention is a quantitative seismic interpretation (QI) workflow integrates three advanced methodologies to address these challenges, as shown in FIG. 2 as process 200. At operation 20, the process received seismic data. At operation 21, the time-depth relationship (TDR) and seismic well-tie are done. This is an automated depth calibration to calculate time-to-depth relations and seismic well-tie. The automatic well-tie system module, using Parallel Tempering MCMC (PT-MCMC), automatically generates an optimized TDR and reflectivity model by exploring a large number of well-tie parameter perturbations (e.g., considering a few tens of thousands)—far beyond human capabilities.

At operation 22, wavelet estimation is done. This is accomplished using a Deep Neural Network (DNN), trained on synthetic data generated by convolving a nominal wavelet with various reflectivity models. The DNN extracts accurate wavelet characteristics from seismic data. The reflectivity model used here is from operation 21, ensuring consistency.

The reflectivity model from operation 21 and the estimated wavelet from operation 22 are passed on to operation 23 for amplitude variation with angle (AVA) inversion. This is a DNN-based seismic AVA inversion. A physics-based DNN inversion module directly predicts impedance from seismic data. This module leverages both a data augmentation strategy using random kernel convolution and a training data generation approach based on the physics of reflectivity modeling (using, for example, the Zoeppritz equation).

A key innovation of this novel approach is the automated generation of an optimized Time-Depth Relationship (TDR) and reflectivity model by the depth calibration component 102. This module explores numerous perturbations of well-tie parameters-far exceeding the capabilities of human operators—to yield a statistically robust TDR. With this optimized TDR, the subsequent DNN-based wavelet estimation produces a wavelet that more accurately represents the Earth's response. Consequently, the seismic inversion results are higher in resolution and align better with well-log data. In the following sections, we describe our integrated workflow, detail its components, and present a case study comparing manual well-tie and automatically-generated TDRs.

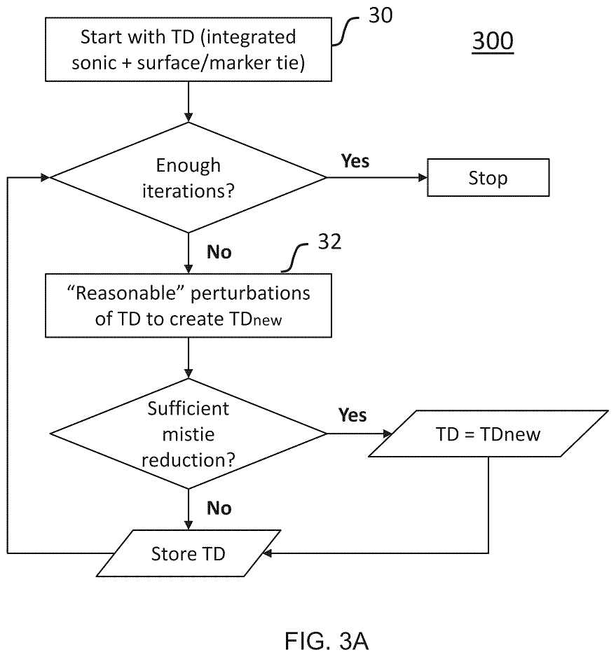

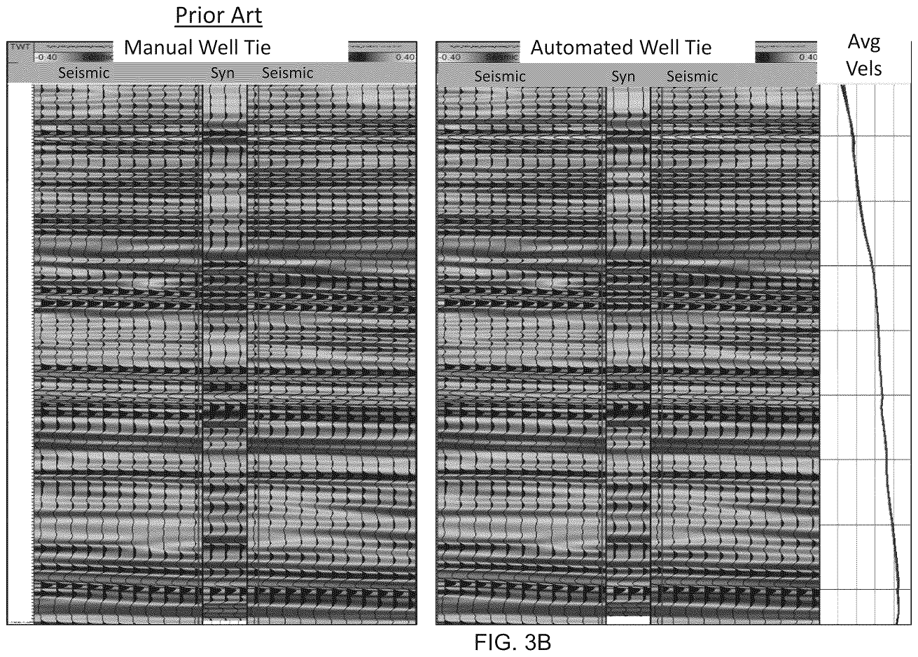

FIG. 3A illustrates a workflow 300 for automated depth calibration to calculate time-to-depth relations and seismic well-tie, as performed by depth calibration component 102 and operation 21. The workflow begins by incorporating prior information from experience and physics to constrain the time-depth (TD) relationship, recognizing that implied velocity changes cannot be large and that only minimal adjustments should be made after an initial bulk shift. An initial TD model is established using integrated sonic data and surface or marker ties (operation 30), after which the process iteratively applies “reasonable” perturbations to the TD (operation 32) to generate an updated TDnew. At each iteration, the method evaluates whether sufficient mistie reduction has been achieved and whether enough iterations have been performed; if not, the TD is updated and the process repeats. Once the mistie reduction criteria are satisfied, the final TD is stored and the workflow terminates, ensuring convergence with the least number of physically plausible changes.

FIG. 3B compares a manual well tie result against a result of the automated depth calibration done in the present invention. Observations indicate that the automatically-generated TDR, although differing only slightly (by a few milliseconds) from the manual TDR, leads to significant improvements in the subsequent steps. With the optimized TDR, the DNN-based wavelet estimation yields a wavelet that is better shaped (closer to a Ricker wavelet) and exhibits more centralized energy. This improved wavelet then feeds into the seismic AVA inversion module, which produces higher-resolution impedance results that align closely with well-log data. These findings highlight that:
The accuracy of the TDR is critical for the overall inversion quality. A high-quality TDR is necessary for a fair evaluation of seismic inversion since inversion quality is ultimately assessed by its agreement with well-log data. The automated QI workflow reduces human bias and manual labor, while ensuring that the optimized TDR drives the accuracy of wavelet estimation and inversion.
TDR quality is critical to the entire inversion process (more than well-tie). TDR and inversion are coupled: TDR should be evaluated quantitatively by inversion product and vice versa.

The proposed automated QI workflow integrates three automated methodologies to streamline reservoir property estimation. By automatically generating an optimized Time-Depth Relationship (TDR) using automated well tie with PT-MCMC, the workflow captures a vast number of well-tie parameter perturbations that are beyond manual capabilities. This optimized TDR, along with the fixed reflectivity model, allows the DNN-based wavelet estimation to accurately extract wavelet characteristics that reflect the Earth's true response. Consequently, the physics-based DNN inversion, bolstered by synthetic training data derived from rock physics models and a robust data augmentation strategy, produces high-resolution impedance results that are well-aligned with well-log data. The case study demonstrates that even small differences in the TDR, imperceptible in manual processing, can substantially enhance inversion quality. In addition, the results indicate that the proposed workflow can further enhance the value of 3D seismic data for exploration, asset development, and production by enabling high-quality inversion results with a speedy, user-friendly process. Ultimately, the integrated workflow reduces human bias and labor, ensuring accurate and streamlined reservoir property estimation. The novelty of this approach lies in the integration of an automated well-tie system with advanced MCMC sampling and a DNN-AVA inversion workflow, which enables fast iteration between TDR and inversion to achieve an optimal solution.

The full methodology of the automated QI workflow is:

1. Automated Depth Calibration using automated well-tie generation with PT-MCMC Data Acquisition and Preprocessing: Well logs, such as sonic and density logs, are first preprocessed to compute acoustic impedance: Z=_{ρ}Vₚ

where ρ is density and Vₚ is compressional velocity. Seismic data are resampled and filtered to match the resolution of the well logs.

Depth-to-Time Conversion: A baseline time-depth model is derived by integrating interval velocities:

$${t}_{n} = {t}_{top} + 2 {\sum }_{0}^{N - 2} \frac{{z}_{i + 2} - {z}_{i + 1}}{{v}_{i + 2}} ,$$

with trop as the reference time. This model is then refined using a parametric transformation:

$$[ {t}_{j}^{′} = {t}_{j - 1}^{′} + α , {t}_{j} = {t}_{j - 1} + β ]$$

where α (stretch) and β (shift) are constrained by geologic considerations.

Exploration with PT-MCMC: The automated well-tie module employs PT-MCMC to explore a vast number of well-tie parameter perturbations. In PT-MCMC, multiple Markov chains are run concurrently at different temperatures Tᵢ, allowing for extensive global exploration of the model space. The acceptance probability for swapping states between chains (i) and (j) is given by:

$$α ( i , j ) = min \{ 1 , {[ \frac{p ( {m}_{j} \vert d )}{( p ( {m}_{i} \vert d )} ]}^{\frac{1}{{T}_{1}} - \frac{1}{{T}_{j}}} \}$$

where p(m|d) is the posterior probability of the model (m) given the data (d). This automated process considers a multitude of perturbations—far beyond manual capabilities—and results in an optimized TDR and reflectivity model.

### 2. DNN-Based Wavelet Estimation

With the optimized TDR and fixed reflectivity model from the automated well-tie module, the seismic trace s(t) is modeled as: s(t)=w(t)*r(t)+n(t), where w(t) is the unknown wavelet, r(t) is the reflectivity, and n(t) is noise.

Synthetic Data Generation and Training: A synthetic training dataset is created by convolving a nominal wavelet (e.g., a 25 Hz Ricker wavelet) with a variety of reflectivity models. A deep neural network (DNN) is then trained to learn the mapping from seismic data s(t) to the estimated wavelet wₑₛₜ(t). The network is optimized by minimizing the loss function

$${L}_{wavelet} = \frac{1}{2} {\vert s ( t ) - {w}_{est} ( t ) ⋆ r ( t ) \vert}^{2} + λ {\vert θ \vert}_{1}$$

where θ represents the network parameters and λ is a regularization coefficient. Dropout and L1 regularization are applied to improve generalization. While this approach was originally introduced to simultaneously invert for both the wavelet and reflectivity model, our method fixes the reflectivity obtained from the depth calibration stage and estimates only the wavelet. This refinement ensures that the estimated wavelet more accurately conveys the Earth's true response.

### 3. DNN-Based Seismic AVA Inversion

DNNs are deep-learning methods capable of modeling complex nonlinear relationships between input and output parameters. For accurate AVA inversion, we apply a physics-based DNN approach. Unlike conventional DNN methods that use field log and seismic observations directly as training data, our physics-based approach generates training data from the well-known physics of reflectivity modeling, particularly using the Zoeppritz equation. A training pair consists of synthetic P- and S-wave velocities and density logs (i.e., Vₚ, Vₛ, and ρ sampled from rock physics models built from field log data, along with the corresponding synthetic seismic trace. This enables the generation of a large number of high-quality training pairs, which is advantageous because field seismic data are normally noisier than field log data.

Data Augmentation Strategy: In addition to the physics-based training data, training pairs are further augmented by convolving both the seismic data d and reflectivity r with a random stationary kernel (K):

$$\tilde{d} = K \times d , \qquad \tilde{r} = K ⋆ r$$

Assuming the seismic wavelet (W) is stationary, (K) and (W) commute, preserving the underlying physics while enhancing the diversity of the training dataset.

CNN Architecture and Inversion Loss: A convolutional neural network (CNN) is designed to directly predict acoustic (or elastic) impedance (I) from seismic traces. The inversion is achieved by minimizing:

$${min}_{θ} {\vert I - {\hat{F}}_{θ} ( d ) \vert}^{2} + λ {\vert Δ I \vert}_{1}$$

where \hat{F}θ is the CNN mapping function and ∇I denotes the spatial gradient of the impedance profile, enforcing smooth and geologically plausible inversion results.

The disclosed automated QI workflow, exemplified by the integration of an McMC-based automated well-tie system and a DNN-AVA inversion workflow, can further enhance the value of 3D seismic for exploration, asset development, and production. The products are designed to enable high-quality inversion results, accessible by general users with or without a QI background, and provide a speedy process to obtain insight from data quickly.

The proposed automated QI workflow integrates three automated methodologies to streamline reservoir property estimation. By automatically generating an optimized Time-Depth Relationship (TDR) using automated well-tie with PT-MCMC, the workflow captures a vast number of well-tie parameter perturbations that are beyond manual capabilities. This optimized TDR, along with the fixed reflectivity model, allows the DNN-based wavelet estimation to accurately extract wavelet characteristics that reflect the Earth's true response. Consequently, the physics-based DNN inversion, bolstered by synthetic training data derived from rock physics models and a robust data augmentation strategy, produces high-resolution impedance results that are well-aligned with well-log data. The case study demonstrates that even small differences in the TDR, imperceptible in manual processing, can substantially enhance inversion quality. In addition, the results indicate that the proposed workflow can further enhance the value of 3D seismic data for exploration, asset development, and production by enabling high-quality inversion results with a speedy, user-friendly process. Ultimately, the integrated workflow reduces human bias and labor, ensuring accurate and streamlined reservoir property estimation. The novelty of this approach lies in the integration of an automated well-tie system with advanced McMC sampling and a DNN-AVA inversion workflow, which enables fast iteration between TDR and inversion to achieve an optimal solution.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for automated quantitative seismic interpretation, comprising:
a. receiving, by one or more processors, seismic data representative of a subsurface volume and well log data from at least one well;
b. automatically generating a time-to-depth relationship (TDR) by performing an automated seismic well-tie operation that includes:
i. perturbing one or more well-tie parameters across a plurality of candidate models, and
ii. statistically evaluating the plurality of candidate models using a parallel tempering Markov-Chain Monte Carlo (PT-MCMC) sampling process to determine an optimized TDR and a corresponding reflectivity model;
iii. fixing the reflectivity model determined from the optimized TDR;
c. estimating, using a deep neural network (DNN), a seismic wavelet by:
i. training the DNN using synthetic training data generated by convolving a nominal wavelet with a plurality of reflectivity models, and
ii. applying the trained DNN to the seismic data while holding the reflectivity model fixed to produce an estimated seismic wavelet;
d. performing seismic amplitude variation with angle (AVA) inversion using a physics-based deep neural network, wherein:
i. training data for the physics-based deep neural network are generated using reflectivity modeling based on rock-physics parameters, and
ii. the estimated seismic wavelet is used as an input to the AVA inversion; and
e. generating, based on the AVA inversion, one or more subsurface property models that are quantitatively aligned with the well log data, wherein the automated generation of the optimized TDR, the wavelet estimation, and the AVA inversion are performed without manual well-tie adjustment.

2. The method of claim 1, wherein the well log data comprise at least one of sonic logs, density logs, compressional velocity logs, or shear velocity logs.

3. The method of claim 1, wherein the seismic data are resampled and filtered to match a temporal resolution of the well log data prior to automated well-tie generation.

4. The method of claim 1, wherein the one or more well-tie parameters comprise stretch parameters, shift parameters, or combinations thereof.

5. The method of claim 1, wherein the automated seismic well-tie operation explores at least tens of thousands of candidate well-tie models.

6. The method of claim 1, wherein the optimized TDR is selected based on a statistical evaluation of posterior probability across the plurality of candidate models.

7. The method of claim 1, wherein the automated seismic well-tie operation generates both the optimized TDR and the reflectivity model simultaneously.

8. The method of claim 1, wherein the reflectivity model is fixed during wavelet estimation to decouple wavelet estimation from reflectivity inversion.

9. The method of claim 1, wherein the synthetic training data are generated by convolving the nominal wavelet with a plurality of reflectivity models having different spectral characteristics.

10. The method of claim 1, wherein the deep neural network used for wavelet estimation is trained using regularization techniques comprising at least one of dropout regularization or L1 regularization.

11. The method of claim 1, wherein the estimated seismic wavelet exhibits increased temporal compactness and centralized energy relative to a wavelet estimated using a manually generated TDR.

12. The method of claim 1, wherein training data for the physics-based deep neural network are generated using reflectivity modeling derived from rock-physics parameters.

13. The method of claim 1, wherein the physics-based deep neural network comprises a convolutional neural network (CNN).

14. The method of claim 1, wherein the AVA inversion predicts acoustic impedance, elastic impedance, or both.

15. The method of claim 1, further comprising augmenting training data by convolving seismic data and reflectivity with a random stationary kernel.

16. The method of claim 15, wherein the random stationary kernel commutes with a stationary seismic wavelet to preserve physical consistency.

17. The method of claim 1, wherein the one or more subsurface property models are quantitatively evaluated based on alignment with measured well log data.

18. The method of claim 1, wherein inversion quality is used as a metric to evaluate the optimized TDR.

19. The method of claim 1, wherein iterative refinement between TDR optimization and AVA inversion is performed to improve overall inversion accuracy.

20. The method of claim 1, wherein the automated quantitative seismic interpretation workflow is executable by a user without manual adjustment of well-tie parameters.

21. The method of claim 1, wherein the workflow reduces subjective interpreter bias relative to manual seismic interpretation workflows.

22. A computer system for automated quantitative seismic interpretation, comprising:
one or more processors;
memory storing instructions that, when executed by the one or more processors, cause the system to:
a) automatically generate an optimized time-to-depth relationship (TDR) and reflectivity model using an automated well-tie process with parallel tempering Markov-Chain Monte Carlo (PT-MCMC) sampling;
b) estimate a seismic wavelet using a deep neural network trained on synthetic seismic data while fixing the reflectivity model generated from the optimized TDR;
c) perform physics-based deep neural network seismic amplitude variation with angle (AVA) inversion using the estimated seismic wavelet; and
d) output subsurface property estimates that are quantitatively consistent with well log measurements.
